(19) United States
(12) Patent Application Publication
(10) Pub. No.: US 2008/0183566 A1
(43) Pub. Date: Jul. 31, 2008

(54) EPISODIC SHOW, DEVICE AND SYSTEM OPERABLE TO PRODUCE A PROMOTIONAL EFFECT

(76) Inventor: John R. Montgomery, Northbrook, IL (US)

Correspondence Address: BELL, BOYD & LLOYD, LLP, P.O. Box 1135, CHICAGO, IL, 60690, US

(21) Appl. No.: 11/627,678

(22) Filed: Jan. 26, 2007

(51) Int. Cl. G06Q 30/00; H04N 7/00; G06Q 99/00

(52) U.S. Cl. 705/14; 348/844; 348/E07.001

(57) ABSTRACT

A show including a series of episodes. Each one of the episodes includes a plot which varies with each one of the episodes and a plurality of characters who are affiliated with a service company. The service company is involved with a plurality of different commodities which are commercially available outside of the show. At least one of the characters has a role in some or all of the episodes. Each of the episodes includes at least one noncomplimentary act that is performed by at least one of the characters. The noncomplimentary act does not expressly compliment the commodity and is performable to produce a promotional effect for at least one of the commodities with respect to one or more viewers of the episode.

### COPYRIGHT NOTICE

A portion of the disclosure of this patent document contains or may contain material which is subject to copyright protection. The copyright owner has no objection to the photocopy reproduction by anyone of the patent document or the patent disclosure in exactly the form it appears in the Patent and Trademark Office patent file or records, but otherwise reserves all copyright rights whatsoever.

### BACKGROUND

Product manufacturers commonly advertise their products in commercials. Commercials generally are broadcast during commercial breaks in the middle of a television show or in-between television shows. Consumers often seek to avoid commercials by muting the television, turning the channel or simply walking away from the television. Consumers also use electronic devices which record desired shows enabling the consumers to limit their watching of commercials. As a result, the advertisement value of commercials has declined.

In addition to commercials, manufacturers sometimes pay to have their products incorporated into television shows and motion pictures. This technique is sometimes referred to as product placement or embedded communications. For example, a soft drink manufacturer may pay to have the main character in a motion picture drink a can of its soft drink. One disadvantage with this technique is that viewers may not pay attention to the product in the show or motion picture depending upon the circumstances. One cause for overlooking the product is that the viewers may be focused on the plot of the show, and the product may not be related to the plot.

Therefore, there is a need to overcome such disadvantages, lessen the effects of such disadvantages or otherwise provide improvements applicable to the process of advertising, promoting or marketing products and services.

### SUMMARY

The promotional system, in one embodiment, includes a show or an episodic series of shows, such as a television show or a television series, and a related website. The show or series and the website can be operated cooperatively or independently to produce a promotional effect for products and services. The term “commodity” is used herein, at times, as a reference to a product or a service, or a product and service combination. In one embodiment, the show is a commercial-free entertainment program, such as a sitcom or a drama, which includes a series of episodes centered around a service company which interfaces with different commodities, such as an advertisement agency. In one example, the show is a comedy based on the lives of co-workers of the service company. Consequently, the plots, subplots and climaxes of the episodes engage the viewers with commodities in a comedic fashion as part of the storyline. As a result, commodities can be promoted without expressly praising or complimenting the commodities. In one embodiment, the show includes at least one noncomplimentary act related to a commodity to draw the viewer's attention to the commodity. The noncomplimentary act can be a neutral comment, a negative comment, a combination of a negative and positive comment, or any suitable combination of the foregoing. By intertwining these noncomplimentary acts and commodity topics into the plots and subplots of the episodes, the show causes an effect which increases commercial interest in, and awareness of, the commodities which, in turn, can increase sales of the commodities.

In one embodiment, the website enables the public to submit commodity-related content or concepts, such as proposed advertisements, for possible inclusion in the show. The website also enables the public to participate in a variety of online activities which involve or relate to different commodities. As a result, the website facilitates the building of a community of viewers, fans and freelancers who can support the show which, in turn, enhances the promotional effects of the show.

Additional features and advantages are described herein, and will be apparent from, the following Detailed Description and the figures.

### BRIEF DESCRIPTION OF THE FIGURES

FIG. 1 is a schematic block diagram of one embodiment of the promotional system including the show and the network architecture.

FIG. 2 is a flow chart illustrating a payment process for the payor to pay an implementer of one embodiment of the promotional system.

FIG. 3 is a flow chart illustrating a payment process for the payor to pay various implementers of one embodiment of the promotional system.

FIG. 4 is a schematic block diagram of one embodiment of the network architecture illustrating the advertisement agency, the computer system, the server, the internet, advertisement concepts, the website including webpages, a selection filter and advertisements provided to the show and a non-show event of one embodiment of the promotional system.

FIG. 5 is a flow chart illustrating the advertisement concepts being provided to the show and to non-show events in one embodiment of the promotional system.

FIGS. 6A to 6E are screen shots of different embodiments of example webpages illustrating various virtual rooms of the website of one embodiment of the promotional system.

FIG. 7 is a flow chart illustrating a payment process for the payor to pay various implementers of one embodiment of the promotional system.

### DETAILED DESCRIPTION

### Promotional System

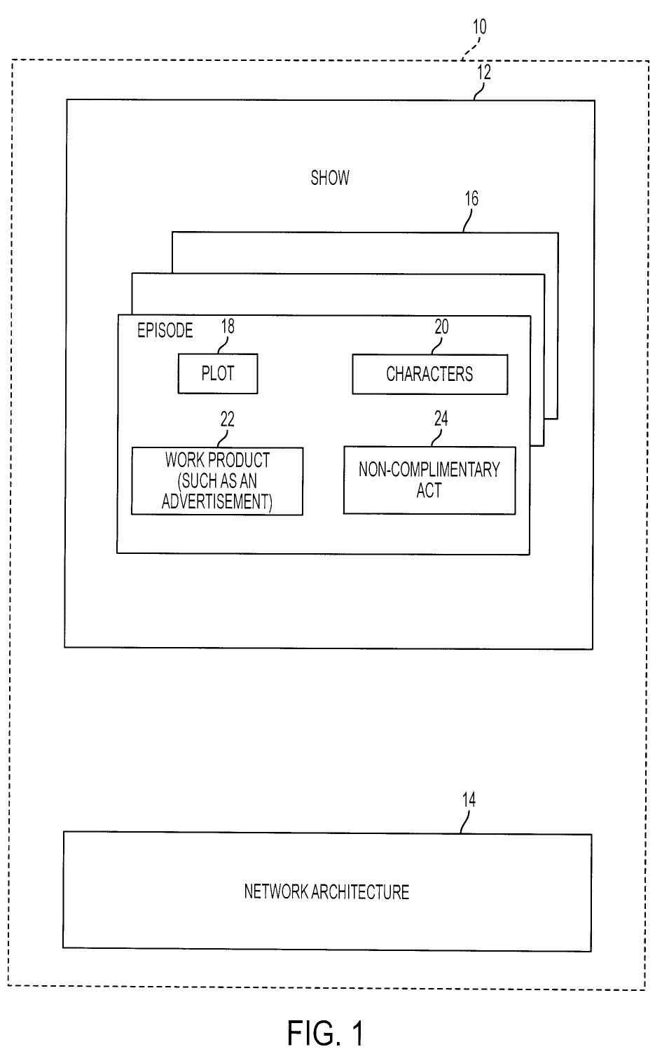

Referring now to the drawings, the promotional system 10 includes a program or show 12 associated with a network architecture 14, as illustrated in FIG. 1. The network architecture 14 is shown in phantom because, as described below, the promotional system 10 can include or exclude the network architecture 14 depending upon the embodiment. The promotional system 10 produces a promotional effect for one or more commodities which are commercially available in the marketplace or which are intended to be marketed in the future. It should be understood that the promoted commodities are actual commodities marketed outside of the show 12. The promotional system 10 can produce, generate, cause or develop promotional effects for commodities through the show 12 alone or as part of the network architecture 14 described below.

### Show

In one embodiment, the show 12 is an episodic television program or show having a series of episodes in video format. It should be appreciated that the show 12 can be embodied in a plurality of different mediums or formats, including, but not limited to, movies, motion pictures, live performances (such as plays and operas), books, data feeds (such as video streams and podcasts) and any other suitable type of medium or communication channel or forum. It should also be appreciated that the show can be stored or recorded in any suitable data storage device or recording medium, including, but not limited to, a database, a server, a disk and a magnetic tape.

In one embodiment, the show 12 is formatted to be broadcast over a network. In one embodiment, the network is a broadcast television network sometimes referred to as a terrestrial or over the air (OTA) network. It should be appreciated that the show 12 can be formatted to be performed on any suitable network, including, but not limited to, a cable television network, a satellite television network or the internet. In one embodiment, the show 12 has a commercial-free format during which the show 12 has no commercial breaks or interruptions. In one embodiment, each episode 16 has a length of twenty-two, twenty-four or twenty-eight minutes, though the episode 16 can have any suitable length of time. In the commercial-free embodiment, the show 12, much like a motion picture, is adapted for post-broadcast use in Digital Video Disks (DVDs), on the internet, in podcasts and in other mediums. It should be appreciated, however, that show 12 can be formatted to have commercial breaks in other embodiments. In certain embodiments, the show 12 may be edited to include commercials after the show 12 has been broadcast or performed. For example, for syndication, the show 12 can be edited to include one or more conventional commercial breaks.

Referring again to FIG. 1, in one embodiment, the show 12 includes a comedy or sitcom based on the lives of a group of employees of a service company, such as an advertisement company or agency. The sitcom has a plurality or series of performances, installments or episodes 16. It should be appreciated that the show 12 can include any suitable number of episodes 16. In one embodiment, each episode 16 includes at least one plot 18; a cast or a plurality of characters 20; at least one noncomplementary act 22 that produces a promotional effect for a commodity in the marketplace; and work product 24 relating to one or more of the characters 20. Each episode 16 also includes the other standard elements of a sitcom, such as a climax, multiple acts, multiple scenes, interior sets, exterior sets and the other elements specified by what is commonly known as a spec script. It should be appreciated that not all of the episodes 16 must include this combination of plot 18, characters 20, noncomplementary act 22, and work product 24. Depending upon the embodiment, one or more episodes 16 can include any suitable part or combination thereof. For example, in an embodiment in which the show 12 is not based on a service company, the show 12 does not include work product 24.

In one embodiment, each of the episodes 16 includes a story that includes at least a main plot 18 about which the episode 16 is centered. In another embodiment, each episode 16 includes a main plot 18 and at least one subplot. It should be appreciated that the main plot 18 or subplot may involve any suitable number of characters 20, at least one of which has a recurring appearance from episode to episode.

In one example, the service company around which the show 12 is based is an advertisement company or agency. It should be appreciated, however, that the service company can include any entity or organization which is involved with a plurality of commodities, including, but not limited to, an advertisement company, a marketing company, a promotion company, a brand development company, a distribution company, a company which reviews products of a plurality of different entities, a company which develops products for a plurality of different entities, a company which designs products for a plurality of different entities, a financial institution, a bank, a lender, a payor 26, a product manufacturer, a service provider, a commodity provider, a commercial production company, a casting agency, a venture capital company, an investor, and a stock analyst company. Depending on the embodiment, the work product 24 can be an advertisement created for a client's commodity; a brand development campaign created for a client's commodity; a review report or rating for a product category, such as mobile phones on the market; an investment solicitation report focused on, for example, blue chip consumer product corporations; or any other type of work product associated with the applicable service company.

In one embodiment, some of the characters 20 are affiliated with the service company, and other characters 20 are not. For example, ten of the fifteen characters may work for the service company, three of the characters may be relatives of the service company workers, and two characters may be people the workers interact with outside of the service company. It should also be appreciated that the characters 20 can be portrayed, in one embodiment, as agents or affiliates of the service company rather than workers or employees of the service company.

In one embodiment, each episode 16 includes a climax, such as a problem or dilemma which is related to the main plot 18 of the show 12. The climax can also be directly or indirectly related to the promoted commodities. For example, the climax of one episode 16 may be based on a wardrobe problem of the main character which creates problems with a blue jean advertisement assignment. In another example, the climax of another episode 16 may be based on the main character's obsession to conserve electricity in the course of his or her employment with an advertisement agency or product review company.

In one embodiment, each of the episodes 16 includes one or more noncomplimentary acts 22 which are performed by one or more of the characters 20. Each noncomplimentary act 22 contributes to the production of a promotional effect for at least one of the commodities with respect to the viewers of the episode. In one embodiment, the noncomplimentary act 22 does not expressly compliment the promoted commodities, though it should be appreciated that the noncomplimentary act 22 does not have to involve negativity or disparagement. The noncomplimentary act 22, in one embodiment, does not involve a direct, express or conspicuous advertisement or promotion of the promoted commodities. Instead, the noncomplimentary act 22 is an event or sequence of events in an episode 16 which relate to the promoted commodities. For example, the noncomplimentary act 22 may be a joke about a product made during a brainstorming session for advertisement concepts for the product. In another example, the noncomplimentary act 22 may be a passing reference to a widget A product, such as: (smiling) “Look, now grandma's buyin' a widget A.” In another example, the noncomplimentary act 22 may be a statement about a widget B water product, such as: (incredulously) “Widget B, can you believe we're paying so much for water these days?” In yet another example, the noncomplimentary act 22 may be a negative statement about a type of widget C, such as: (frowning) “Does the world really need yet another widget C?”

Whether or not the noncomplimentary act 22 is negative, the noncomplimentary act 22 can include various types of acts, behaviors or events, including, but not limited, to disparagement, mockery, parody, jokes, poking fun, irreverence, funny descriptions, satire, negative connotations, negative denotations and factual descriptions. In one embodiment, the noncomplimentary act 22 is pointing out a competitor's flaws. In another embodiment, the noncomplimentary act is providing or indicating an alternate, unintended or unusual use for a commodity. In one embodiment, the noncomplimentary act 22 includes a positive act with a negative spin or any suitable combination of negative and positive activities. For example, character Tom may say that product A is good and then character Jan may laugh and say that Tom made a ridiculous statement.

In one example where the show is based on co-workers at an advertisement company, the work product 24 is an advertisement for a commodity of a client of the advertisement company. The advertisement is portrayed as the work product of one or more co-workers of the advertisement company. In one embodiment, the advertisement is only used within the context of the show 12. That is, the advertisement is a unique advertisement created for the show 12. In one such embodiment, the advertisement is portrayed as a result of the work conducted by at least one of the characters 20 for a client of the advertisement company. In another embodiment, the advertisement is usable both inside the show 12 and outside of the show 12 as described below.

There are a variety of suitable logical relationships between the plot 18, the noncompimentary act 22 and the work product 24. In one embodiment, the noncomplimentary act 22 is a subset of the plot 18. In one embodiment, the work product 24 is a subset of the plot 18. In one embodiment, the noncomplimentary act 22 is the presentation of the work product 24 or character behavior involving the work product 24.

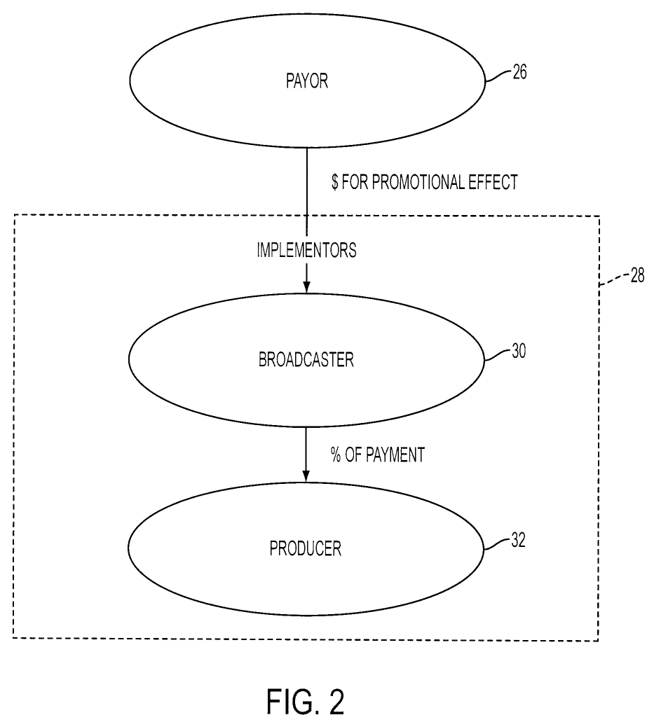

Turning to FIG. 2, the promotional system 10 enables a sponsor or payor 26, such as a product manufacturer, to make a payment to receive a promotion for its product through one or more episodes 16. It should be appreciated that the payor 26 may be any suitable business enterprise, person or group which is affiliated with a promoted commodity, including, but not limited to, a manufacturer of the commodity; an agent for the manufacturer; a provider of the commodity; an agent of the provider; a distributor of the commodity; a marketer for the commodity; or any other entity directly or indirectly engaged in commercializing the commodity.

In operation of the system 10, the payor 26 pays at least one of the implementers 28 of the show 12 in consideration for the promotion of its commodity. In one embodiment, the implementer 28 is a network operator or broadcaster 30, a show producer 32, a show developer or any other person or entity which is capable of implementing the performance of the show 12, alone or in conjunction with others. In the illustrated embodiment of FIG. 2, the system 10 includes a payment arrangement obligating the payor 26 to provide a payment to the broadcaster 30 of the show 12. The broadcaster 30, in turn, provides a percentage of that payment to the producer 32 of the show 12.

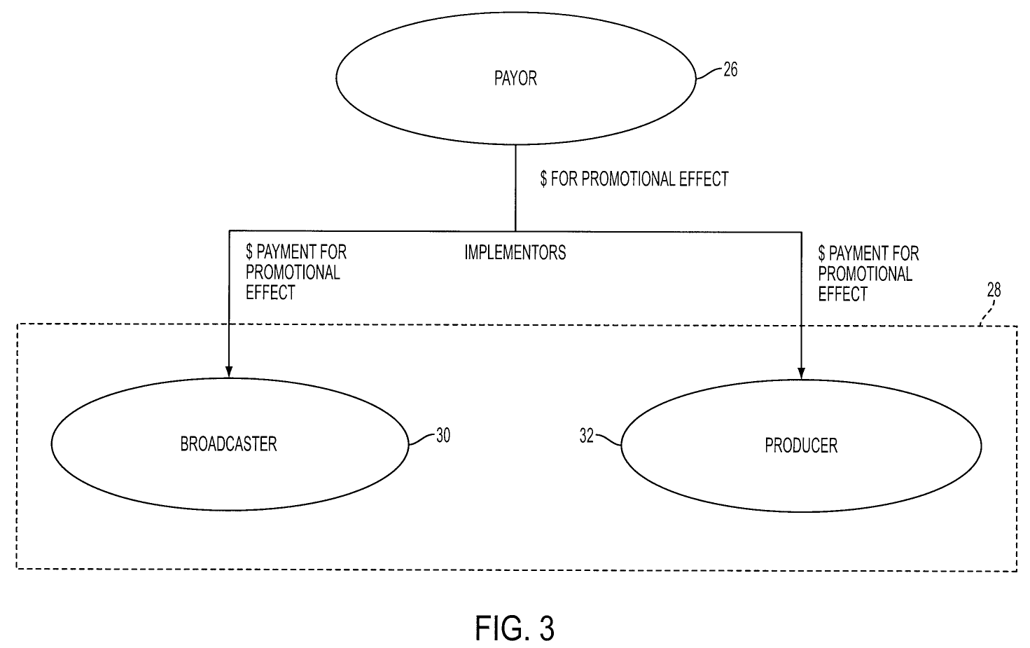

In another embodiment illustrated in FIG. 3, the system 10 has a payment arrangement obligating the payor 26 to provide a plurality of payments to a plurality of implementers 28. In the illustrated embodiment, the system 10 requires the payor 26 to pay the broadcaster 30 for the promotional effect of the show 12, and the system 10 requires the payor 26 to make a separate payment to the producer 32 of the show 12. It should be appreciated that the amount of the payments may be determined in any suitable manner. The payor 26 may make the payments to the different implementers 28 at the same time or at different times.

In one embodiment, the system 10 enables multiple sponsors or payers 26 to sponsor a single episode 16. For example, a sports drink sponsor may fund an episode to have its sports drink incorporated into the episode, and a pharmaceutical company may fund the same episode to have its pain reliever product incorporated into the same episode. In one embodiment, the system 10 includes a funding scale or arrangement which specifies different levels of funding associated with different levels of involvement of a commodity in an episode. The following tables illustrates an example funding arrangement with three involvement levels:

FUNDING ARRANGEMENT

| Payment Option | Involvement Level |
|---|---|
| A | Integration in which the commodity is the focal point |
| | of the main plot of the episode |
| B | Integration in which the commodity is involved in a |
| | subplot or other portion of the episode other than the |
| | main plot. |
| C | Integration in which the commodity is involved in a |
| | portion of the same episode other than at either of the |
| | levels described above. |

In one embodiment of this example, the payment levels decrease from A to C with the decreasing levels of involvement. For an example of payment option A, a beer company may have its beer product as the basis for an advertisement assignment involving most of the characters of the episode. The focal point or the climax of the episode may be the challenge experienced by characters in developing a successful advertisement for the beer product. For an example of payment option B, a toothpaste company may have its toothpaste product involved in a character conversation or subplot of the same episode. For example, some of the characters 20 may be watching television while an entertaining commercial appears on the television for the toothpaste product. In this example, the complete attention of the episode 16 is focused on the toothpaste product for a relatively short period of time. For an example of payment option C, a candy bar manufacturer may have its candy bar included in the same episode as a product placement. For example, a character may drive past a billboard displaying an advertisement for the candy bar, or a character may mention that she has a craving for the candy bar near lunchtime.

In one embodiment of this example, the levels A to C are different levels of promotion, and each commodity receives each level of promotion on one or more shows 12. For example, a commodity has level A promotion on a first show in a season, level B promotion in a fifth show in such season and level C promotion in a sixth show in such season. In one such embodiment, the same commodity of a payor 26 has different levels of promotion over a season or series of shows. Accordingly, the promotional level of a commodity can very through-out episodes of the show 12 or through-out one or more seasons of the show 12.

It should be appreciated that any suitable number of commodities of payors 26 may be included in a single episode 16 or in multiple episodes. In one example, a series of episodes rotate the relative involvement of commodities from episode to episode. In another embodiment, the system 10 may require payers 26 pay different fees. For example, the system may require the payor 26 to pay a production fee and a separate fee for causing a promotional effect for the commodity. In another embodiment, the system requires payors 26 to purchase the same level of promotion. It should be appreciated that the number of commodities and the rotation of the commodities in the show 12 may be implemented in any suitable manner.

### Network Architecture

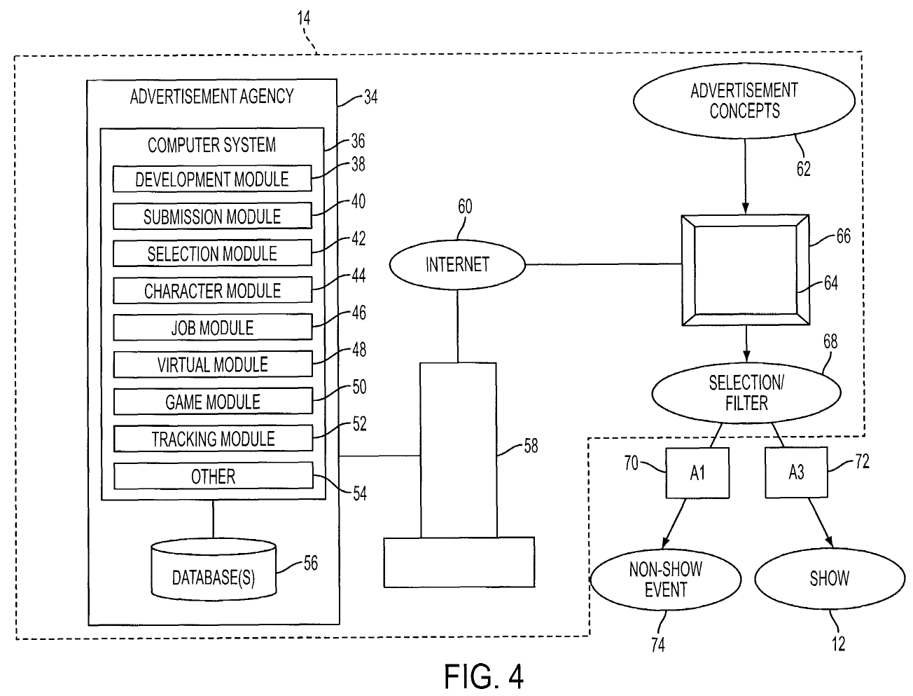

As described above, the show 12, can, in one embodiment, be used in conjunction with the network architecture 14 as illustrated in FIG. 4. In the illustrated example, the network architecture 14 includes a computer system 36 of a marketing or advertisement agency 34 which conducts business outside of the show 12. It should be appreciated that the agency 34 is a real business enterprise with real income and expenses. In one such embodiment, the agency 34 provides certain benefits to the employees of the agency 34, such as training and updates about the agency 34 and fellow employees. In one embodiment, the advertisement agency 34 is a real-world version of the service company of the show 12. In another embodiment, the advertisement agency 34 has workers, some or all of which are the same as the working characters 20 in the show 12. In one embodiment, the advertisement agency 34 is different from and unaffiliated with the service company of the show 14.

In either case, the computer system 36 of the agency 34 is coupled to at least one data storage device or database 56. The computer system 36 includes a plurality of instructions which are readable by one or more processors or servers 58. The instructions are preferably organized into a plurality of computer-readable modules 38 to 54. The one or more servers 58 use the computer system 36 to process information and store data in the one or more databases 56 as further described below. The computer system 36 can be stored on one or more databases, memory devices, data storage devices or code storage mediums, including, without limitation, a disk, hard drive or computer chip.

The server 58 is connected to or otherwise in communication with a suitable electronic network including, but not limited to, a wide area network or a local area network. As illustrated in FIG. 4, the server 58 is connected to the internet 60, and the server 58 is in communication with the computer system 36 as well as the database 56.

The computer system 36 directs the server 58 to present a graphical user interface to a plurality of network users, enabling them to submit advertisement concepts 62 as described below. In the example illustrated in FIG. 4, the graphical user interface includes a plurality of webpages 64 of a website 66 hosted by the server 58. In one embodiment, the website 66 itself is advertised or mentioned on the show 12. For example, people may learn about the website 66 by hearing or seeing information about the website 66 at the end of every episode 16.

In one embodiment, each episode 16 includes a solicitation at the end of the episode 16, encouraging viewers to visit the website 66 and submit advertisement concepts 62 for possible inclusion in the show 12. The users can use any suitable internet access device to access the website 66, including, but not limited to, personal computers, wireless personal digital assistants and wireless phones and other handheld devices. In one embodiment, advertisements on the website, advertisement concepts or other products affiliated with the website 66 are displayed on or otherwise incorporated into the show 12. At the same time, the work product 24, segments of the show or advertisement concepts 62 from the show 12 are displayed or incorporated into the website 66 in any suitable form. Accordingly, both the show concepts and the website concepts circulate throughout the show 12 and the website 66.

In one embodiment, the website 66 enables users to create, edit and submit advertisement concepts 62 to the advertisement agency 34 through the website 66. In one embodiment, the advertisement agency 34 selects or filters the submitted advertisement concepts 62 to use them in the show 12 or in a non-show event 74. The non-show event 74 may be any suitable medium of marketing or advertising for one or more commodities. For example, the non-show event 74 can be a standard commercial for use in a break of a standard televised sitcom, an internet pop-up advertisement, or a poster for a billboard.

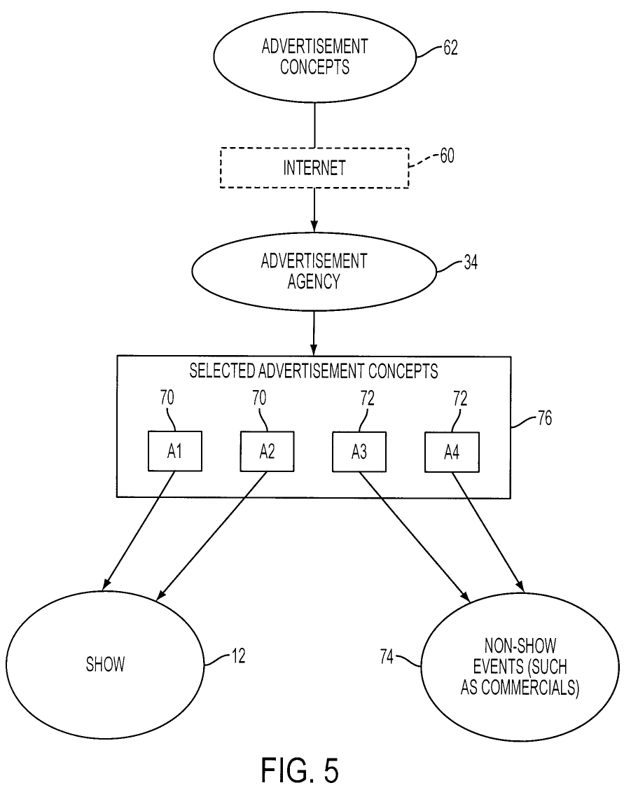

In one embodiment, the advertising agency 34 has a compensation arrangement for users who submit advertisement concepts 62 which are selected by the agency 34. In one embodiment, the compensation arrangement is a multi-tiered monetary compensation plan based on the end use of the advertisement concept 62. As illustrated in FIG. 5, the advertisement agency 34 receives a plurality of proposed advertisement concepts 62 from a plurality of users over the internet 60. The advertisement agency 34 then selects one or a plurality of advertisements 76. The advertisement agency 34 provides certain of the selected advertisements A1 and A2 70 to the implementer of the show 12 for inclusion in one or more episodes.

The compensation plan includes: (a) one payment level (such as $1,000) for each proposed advertisement concept selected by the advertisement agency 34; (b) a higher payment level (such as $10,000) for each proposed advertisement concept incorporated into the show 12 by the show implementer 28; and (c) an even higher payment level (such as $100,000) for each proposed advertisement piece which is actually broadcast in the show 12.

If the advertisement agency 34 selects a proposed advertisement concept A3 or A4 72 for a non-show event 74, such as commercial for an unrelated sitcom, the advertisement agency 34 pays the submitter cash compensation which may vary with the ultimate use of the advertisement concept received from the submitter. It should be appreciated that the advertisement agency 34 may provide the network users with any suitable compensation for any levels of use of the submitted advertisement concepts 72. It should also be appreciated that the advertisement agency 34 can provide non-cash compensation, such as goods, instead of cash compensation. In one such embodiment, the goods available for compensation are the same as, or related to, the goods promoted by the advertisement. In one embodiment, to be awarded for an advertisement concept 62, the actual work product or advertisement submitted by the user does not have to be used but only the advertisement concept 62 itself.

In one embodiment, the advertisement agency 34 provides the employees and payors 26, or sponsors of the advertisement agency 34, with business-related correspondance. For example, the agency 34 provides actual or mock employees with an agency newsletter. In another example, the agency 34 provides actual or mock employees with an identification card verifying employment at the agency 34. In another embodiment, the agency 34 provides payors or sponsors 26 with newsletters or advertisements. It should be appreciated that the business-related correspondance may be presented to actual or mock employees and payors 26 virtually over the internet or may be provided to the actual or mock employees and payors 26 in any other suitable manner, such as through the postal mail.

As generally described above and illustrated in FIG. 4, the computer system 36 includes a plurality of modules 38 which determine the overall functionality of the computer system 36. Each module includes a set of computer readable instructions which are related to a designated subject matter, topic or purpose. This type of modular construction of the computer system 36 can be written using any suitable computer programming language, including, without limitation, object-oriented languages such as commercially available JAVA and C++. In one embodiment illustrated in FIG. 4, the computer system 36 includes modules 38 to 54. However, it should be appreciated that the computer system 36 can include any suitable combination of the modules 38 to 54, including less than all of the illustrated modules 38 to 54. It should also be appreciated that the computer system 36 can be written as a single module or a single set of instructions. In such case, the single set of instructions would have the functionality of the separate modules illustrated in FIG. 4.

### Development Module

Referring to FIG. 4, in one embodiment, the development module 38 enables users to develop the advertisement concepts 62 and also assists users in such process. The development module 38 provides users the tools to create print, audio or video advertisements or promotions which incorporate advertisement concepts 62 to submit to the advertisement agency 34. In one embodiment, any user may develop advertisement concepts 62. For example, users who want to pursue a career in marketing or advertising may develop and submit advertisement concepts 62 to try to begin a career. Students may develop and submit advertisement concepts 62 which are used as part of a scholastic program. In another embodiment, the advertisement agency 34 requires a user to complete certain requirements before developing advertisement concepts 62.

In one embodiment, the development module 38 also enables the users to edit the content of their advertisement concepts 62 once they are created. That is, the development module 38 enables users to change an aspect of a print advertisement or to edit clips of a video advertisement for submission to the advertisement agency 34.

### Submission Module

The submission module 40 enables the users to electronically upload and submit the advertisement concepts 62 that they have developed to the advertisement agency 34 or to the agency's website manager. The submission module 40 may enable the users to submit the advertisement concepts 62 in any suitable manner. In one embodiment, the submission module 40 includes one or more filters which only allow eligible advertisement concepts 62 to be submitted. For example, a user must agree to certain legal terms and enter certain information before submitting an advertisement concept 62. In another example, the advertisement concepts 62-may be limited in size or length, and the submission module 40 ensures that only compliant advertisement concepts 62 are submitted to the advertisement agency 34 or its website manager. In another example, the advertisement agency 34 may provide other rules limiting what type of material is allowable. For example, profanity may not be allowed in the advertisement concepts 62. In one such embodiment, the submission module 40 only enables compliant advertisement concepts 62 to be submitted to the advertisement agency 34.

### Selection Module

In one embodiment, the selection module 42 provides the advertisement agency 34 with the website functionality to screen and select desirable submitted advertisement concepts 62. In one embodiment, the selection module 42 organizes the submitted advertisement concepts 62 in a way to facilitate screening, tracking and selection. For example, the selection module 42 may assign an identifier, score or raking, such as a number, to each of the submitted advertisement concept 62 to enable the advertisement agency 34 to grade, select or reject the submitted advertisement concepts 62.

In another embodiment, the selection module 42 provides website functionality for users or the public to make the selections. For example, each one of the submitted advertisement concepts 62 may be posted on one or more webpages 64, and the selection module 42 may enable users or the public to vote on the submitted advertisement concepts 62.

In another embodiment, the selection module 42 may enable the advertisement agency 34 to initially select one or a plurality of the submitted advertisement concepts 62 and then post the selected submitted advertisement concepts 62 on the webpage 64. The selection module 42 may then enable the public to select or vote on the posted submitted advertisement concepts 62.

It should be appreciated that the selection module 42 may enable the advertisement agency 34, a payor 26 or the public to select, or cast a vote for, submitted advertisement concepts 62 in any suitable manner.

### Character Module

The character module 44 enables the users to explore the characters 20 of the show 12 at the website 66. In one embodiment, the character module 44 enables the website 66 to produce a webcast for each character 20. In another embodiment, the character module 44 enables the website 66 to display a biography for some or all of the characters 20 and extra facts about some or all of the characters 20. In another embodiment, the character module 44 enables the website 66 to display extra footing or segments that were taped but not broadcast on the show 12. In one embodiment, the character module 44 provides the website 66 with the functionality to enable users to monitor the activities of their favorite show characters 20.

### Job Module

In one embodiment, the job module 46 provides the website 66 with the functionality to enable users to seek or carryout jobs, tasks or duties for creating the advertisement concepts 62. In one embodiment, the job module 46 enables the advertisement agency 34 to post jobs that the advertisement agency 34 needs filled. For example, the advertisement agency 34 may have certain payers 26 seeking certain types of promotions or advertisements. The job module 46 also enables the advertisement agency 34 to make online solicitations for the types of promotions or advertisements needed by the advertisement agency 34.

In one embodiment, the website 66, under control of the job module 46, enables certain users to accept certain jobs based on requirements. For example, a number of previous advertisement concepts 62 may need to be submitted before the advertisement agency 34 enables a user to work on the job.

In another embodiment, the job module 46 enables the website 66 to be used by the agency 34 and outside companies to recruit prospective advertisers, interns or marketing students. In one such embodiment, the job module 46 enables users to post sample work for potential employers. Employers may use the website 66 to find employees.

### Virtual Module

In one embodiment, the virtual module 48 provides the website 66 with the functionality to produce and display an interactive virtual work environment for users. As a result, the website 66 enables website users to be mock employees of the advertisement agency 34. Under control of the virtual module 48, the website 66 includes a plurality of webpages 64 which include or display graphical symbols, elements, and other images which form three-dimensional graphical virtual environments for the website visitors. In one embodiment, the virtual module 48, development module 38, submission module 40, job module 46 and game module 50 (described below) are operable together to provide website visitors with a virtual work environment.

In one embodiment, the three-dimensional virtual environments depict an employment building or office space which may include any suitable combination of employment rooms of the agency 34. For example, the three-dimensional virtual office space can include offices (such as a boss's office), cubicles for workers of the agency 34, hallways, a cafeteria, a meeting room, a library, a break room, copy and supply rooms, storage rooms, a lobby, elevators, and stores. In one embodiment, a plurality of these images are interactive. When a user activates an input associated with one of these images, one or more outputs occur including, but not limited to, animations, audio outputs and visual outputs. For example, the virtual module 48 enables website visitors or users to virtually enter rooms, walk down hall ways and virtually interact with other actual or mock employees of the advertisement agency 34.

In one embodiment, the virtual module 48 is operable to produce a virtual award show at the end of the year to reward the agency's actual or mock employees. The advertisement agency may broadcast the award show over the internet. The award show, or a portion of the award show, may be presented in one or more episodes of the show 12. The award show may feature real or fictitious people. In one embodiment, the award show highlights or advertises one or more of the commodities. In one embodiment, the award show is a hiring spot for payors or sponsors. In one embodiment, the advertisement agency provides awards for the payors or sponsors 26 of the show 12 and the website 66. The award show may also provide awards to one or more actual or mock employees of the advertisement agency 34.

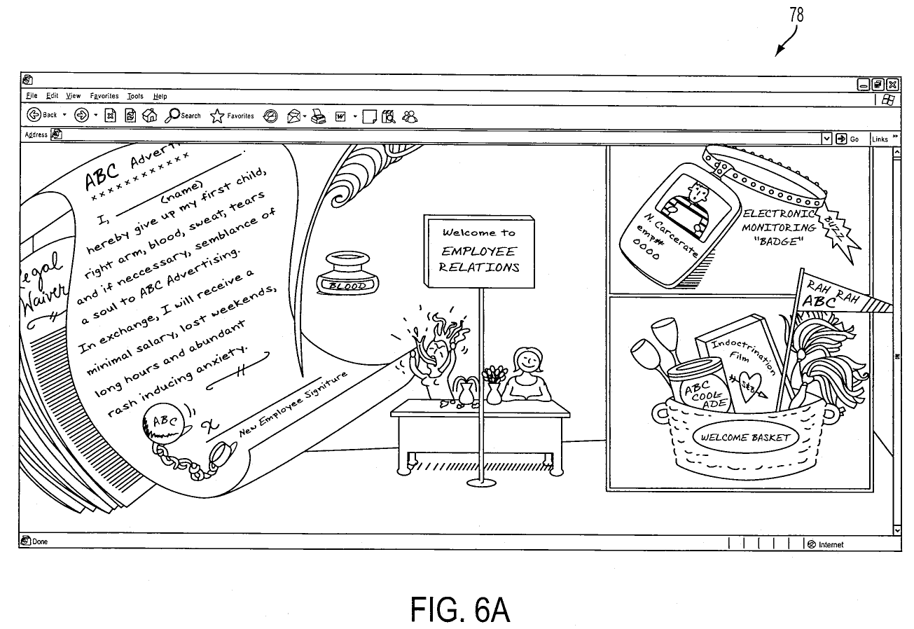

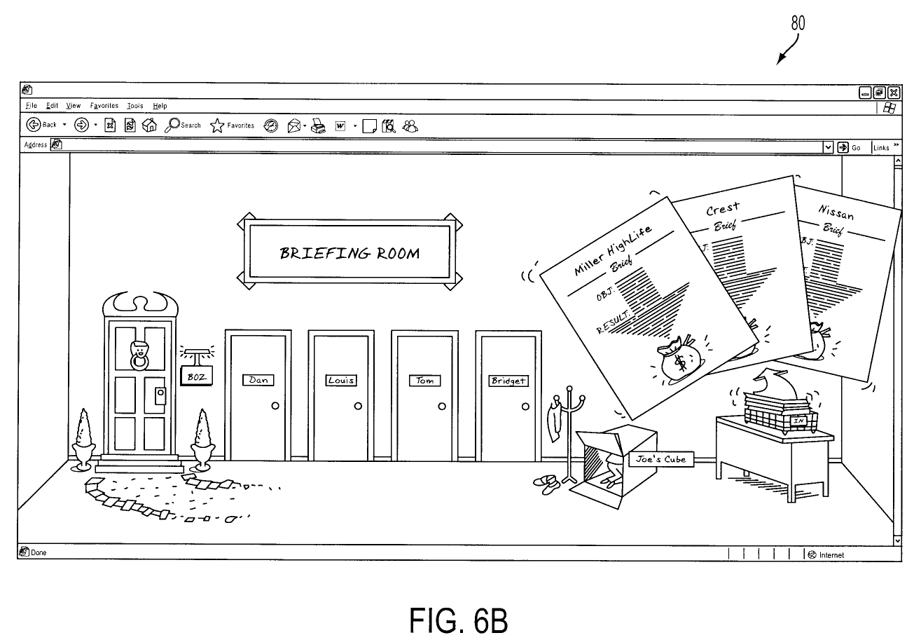

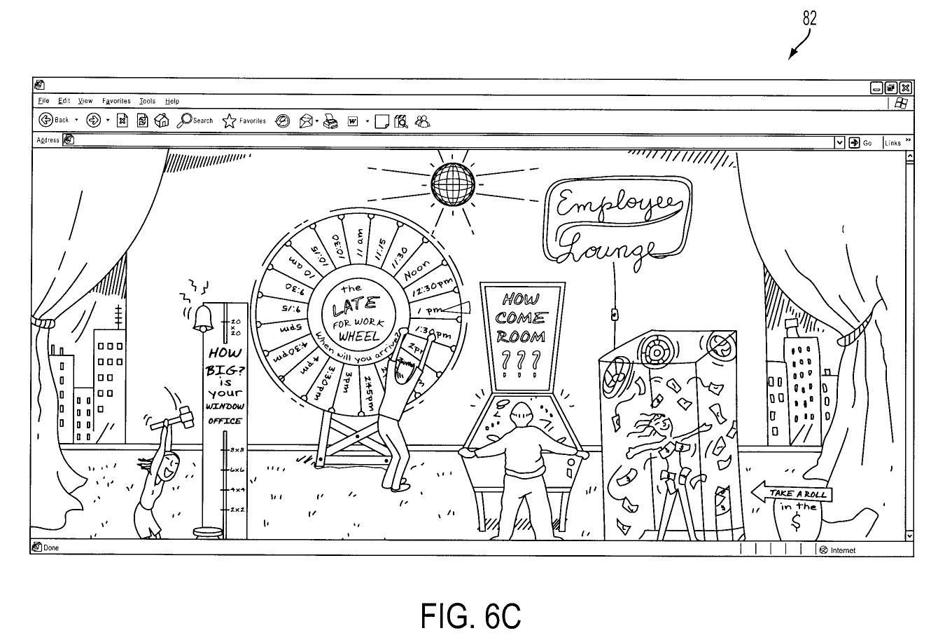

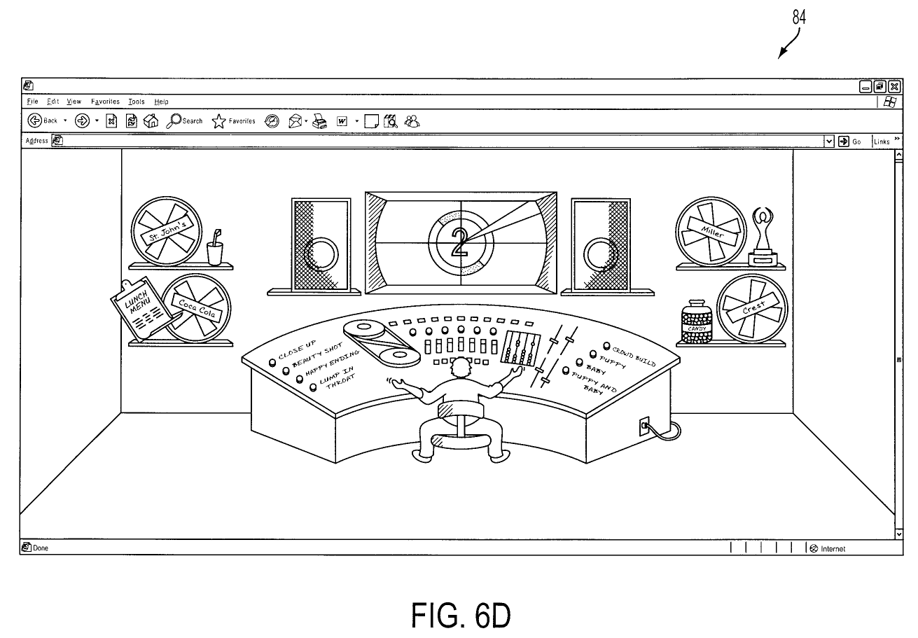

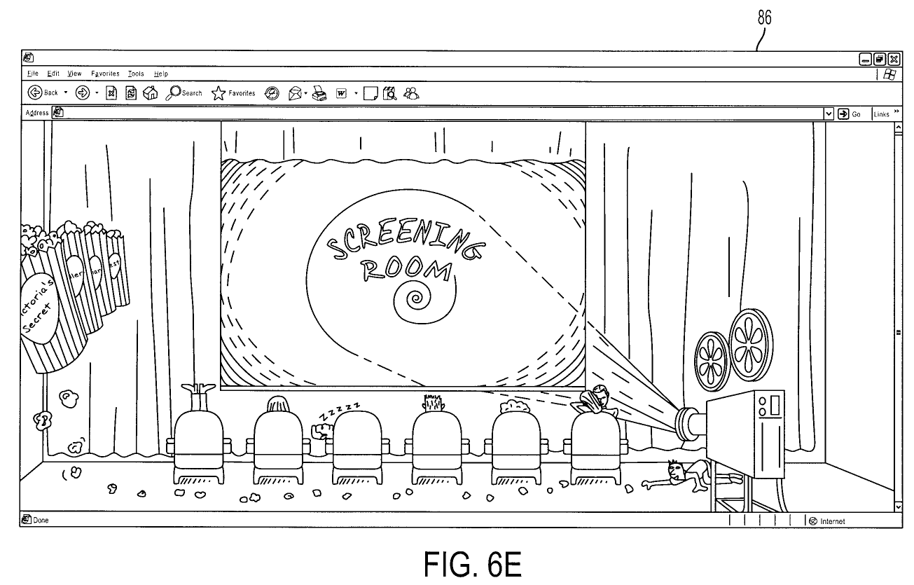

It should be appreciated that the virtual work environment can have any suitable form. For example, the webpages shown in FIGS. 6A to 6E are examples which illustrate the concept of a virtual environment which can help website users feel part of an employment team of the agency 34. For example, FIG. 6A illustrates a screen shot 78 of a webpage 64 of the website 66 welcoming a new user to become an actual or mock employee of the advertisement agency 34. For example, the website 66 provides the new employee a virtual gift basket. In one embodiment, the advertisement agency 34 provides each actual or mock employee an employee number or an identification card. In one embodiment, the advertisement agency 34 requires each actual or mock employee to sign standard employee waivers or contracts.

FIG. 6B illustrates another example screen shot 80 of a webpage 64 of a briefing room where actual or mock employees receive their assignments. It should be appreciated that the virtual module 48 may co-act with the job module 46 to provide users with assignments of the agency 34 or payers 26. For example, the actual or mock employee may receive assignments from a graphical representation or simulation of a character 20 in the illustrated briefing room. The assignment could be a TV commercial, a radio ad or a print ad. In one embodiment, the advertisement agency 34 enables actual or mock employees to select assignments posted by payers 26. In another embodiment, the advertisement agency 34 assigns actual or mock employees to assignments based on their work history with the advertisement agency 34.

FIG. 6C illustrates an example of a screenshot 82 of an employee break room or lounge of the virtual module 48. In one embodiment, the advertisement agency 34 enables the users to play games in the employee break room. In another embodiment, the advertisement agency 34 enables the users to interact in the employee break room through chat sessions or game play. It should be appreciated that the virtual module 48 may provide any suitable type of entertainment for the user. In one embodiment, the virtual module 38 provides the logic for a game room which enables users to play advertisement related games, such as games like “Late for Work,” “The How Come Room,” and “Pitch Meeting.” In one embodiment, the virtual module 38 provides the logic for a plurality of interactive games 118 to 124 in the game room.

FIG. 6D illustrates an example of a screenshot 84 of a virtual editing room of the website 66. In one embodiment, the website 66 also includes creation rooms, such as jingle studios, radio studios and television studios for users or actual or mock employees to develop the advertisement concepts 62.

FIG. 6E illustrates an example of a screenshot 86 of a virtual viewing room of the website 66 for users or actual or mock employees to view their advertisement concepts 62. In one embodiment, the users may ask other actual or mock employees to view their advertisement concepts 62 in the virtual viewing room.

It should be appreciated that any suitable audio, visual, audiovisual or other outputs may be produced by the virtual module 48. In one embodiment, such outputs are determined by a random control process to dynamically vary and change the look and user interaction with the website 66. Here, a database 56 has a randomizer, randomization program or computer code to select and control the various outputs. In one embodiment, the database 56 includes, or is associated with, one or more pools of outputs. The randomizer selects one of the outputs upon an input from a user when designated conditions are satisfied. For example, in the welcome webpage 64 of FIG. 6A, the look or the vocal sound of the employee sitting at the desk 100 may change based on the randomizer and an output pool. For example, the output pool includes a plurality of different images of people. When a user makes a first input to enter the welcome room, the randomizer selects one of the images to sit at the desk, and when the user makes a second input the next day to enter the welcome room, the randomizer generates a different image. In another example, the look or the sound of the editor 102 in FIG. 6D may change from time to time based on the randomizer and an output pool. In another example, the movie watchers 104 to 116 in FIG. 6E may change from time to time or upon an occurrence of an event based on the randomizer and an output pool. For example, different images of people may or may not occupy the seats depending on the time of day. In another example, the output is an audio output. In response to a designated input, the randomizer selects an audio output from a pool of audio inputs. For example, the pool includes a plurality of different voice tones to match with the character images. Upon occurrence of designated events, the randomizer selects different voice tones for different character images to change auditory output of the virtual module 48.

In another embodiment, the randomizer does not completely change the output but changes a portion or a part of the output. For example, in the welcome webpage 64 of FIG. 6A, the color of the outfit of the employee 100 sitting at the desk changes based on the randomizer and an output pool. For example, the output pool includes a plurality of images of different colored shirts. The randomizer changes the color shirt of the employee 100 sitting at the desk. In another example, the output is an audio output and the output pool includes a plurality of different greeting phrases in the same voice tone. Each time the user virtually enters the welcome room, the employee 100 at the front desk auditory greets the user with a different greeting phrase.

It should be appreciated that outputs may be selected in any suitable manner and may include any suitable variances. In one embodiment, the output is based, or is partially based, on the type of input made by a user.

It should be appreciated that the virtual module 48 may be used for any suitable purpose. In one embodiment, the virtual module 48 includes educational and training webpages 64 to help users improve certain skills. In another embodiment, the virtual module 48 includes instructors or teachers to help users learn the basics of advertising, such as learning about the advertising office environment, job descriptions, how advertisement agencies function, and how to roll play jobs. In another embodiment, the virtual module 48 includes instructors or teachers to help users learn skills in the areas of editing, music, radio production, print advertising, and art. In one embodiment, the virtual module 48 includes different virtual rooms or virtual classrooms for different skills or areas of education.

### Game Module

Referring back to FIG. 4, the game module 50, in one embodiment, provides the website 66 with video game functionality. In one such embodiment, the website 66 provides one or more games for the users to play. In one embodiment, at least one game includes an audio, visual or audiovisual component which incorporates an advertisement or embedded communication related to one of the promoted commodities of the agency 34 or the show 12. In another embodiment, at least one of the games involves or relates to one or more of the characters 20 of the show 12. For example, the game may provide quizzes about the characters 20. In one embodiment, the game module 50 co-acts with the virtual module 48 to provide users with games 118 to 124 in a virtual web room, such as the employee break room. In another embodiment, the website 66 provides a game webpage that enables users to participate in games involving the commodities promoted by the agency 34.

### Tracking Module

The tracking module 52, in one embodiment, enables the advertisement agency 34 or payers 26 to monitor the activities of the users while visiting the website 66. In one embodiment, the tracking module 52 provides detailed information, such as which webpages 64 of the website 66 are the most popular or the most visited.

### Other Modules

It should be appreciated that the computer system 36 may include any suitable other 54 types of modules to co-act with the other modules of the computer system 36 or to facilitate the business purposes of the agency 34.

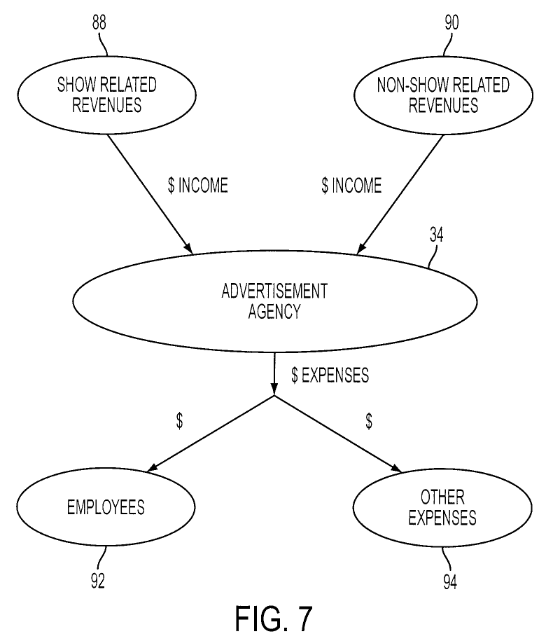

Referring to FIGS. 2, 3 and 7, it should be appreciated that the advertisement agency 34 may have a plurality of sources of income or revenue. In one embodiment, if the advertisement agency 34 creates advertisements used in the show 12, the advertisement agency 34 receives show-related revenues 88 derived from payments made by the payers 26. In one embodiment, the show-related revenues 88 are provided directly to the advertisement agency 34 as illustrated in FIG. 7. In another embodiment, not illustrated, a portion of the show-related revenues 88 may be provided to the advertisement agency 34 and other portions of the show-related revenues 88 may be provided to various implementers 28.

As illustrated in FIG. 7, in one embodiment, the advertisement agency 34 receives non-show related revenues 90, such as earnings based on advertisements services unrelated to the show 12. The advertisement agency 34 uses the incoming revenues to pay expenses 94 of the advertisement agency 34, such as expenses of the website 66, employment compensation 92 for selected advertisements and compensation to its staff. For example, the advertisement agency 34 may pay long-term employees 92 of the advertisement agency 34, such as the managers of the website and the creative directors of the agency. As described above, the advertisement agency 34 can also compensate the user-employees of the website depending on the end use of their advertisement concepts 62.

In one embodiment, the promotional system 10 can be implemented according to the following method:

(a) providing and operating an advertisement agency website;

(b) enabling users to access the advertisement agency website;

(c) enabling users to become actual or mock employees of the advertisement agency website;

(d) enabling users to work in a virtual work environment;

(e) enabling users to develop and submit advertisement concepts through the advertisement agency website;

(f) selecting submitted advertisement concepts to provide to the show or for non-show events;

(g) using certain of the selected submitted advertisement concepts on an episode of the show, wherein the episode includes:
(i) plot which varies with each one of the episodes;
(ii) a plurality of characters who are affiliated with a service company, wherein the service company is involved with a plurality of different commodities which are commercially available outside of the show, and wherein at least one of the characters has a role in all of the episodes;
(iii) at least one advertisement associated with at least one commodity which is commercially available outside of the show; and
(iv) at least one noncomplimentary act performed by at least one of the characters, wherein the noncomplimentary act, though not expressly complimenting the commodity, is performable to produce a promotional effect for at least one of the commodities with respect to one or more viewers of the episode;

(h) using certain of the selected submitted advertisement concepts for non-show events; and

(i) compensating the users of the selected submitted advertisement concepts.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A show comprising:
a series of episodes, each one of the episodes comprising:
(a) a plot which varies with each one of the episodes;
(b) a plurality of characters who are affiliated with a service company, the service company being involved with a plurality of different commodities which are commercially available outside of the show, at least one of the characters comprising a role in all of the episodes; and
(c) at least one noncomplimentary act performed by at least one of the characters, the noncomplimentary act, though not expressly complimenting the commodity, is performable to produce a promotional effect for at least one of the commodities with respect to one or more viewers of the episode.

2. The show of claim 1, wherein the service company comprises an entity selected from the group consisting of an advertisement company, a marketing company, a promotion company, a brand development company, a distribution company, a company which reviews products of a plurality of different entities, a company which develops products for a plurality of different entities, a company which designs products for a plurality of different entities, a financial institution, a bank, a lender, a venture capital company, an investor, and a stock analyst company.

3. The show of claim 1, wherein the noncomplimentary act comprises a statement or behavior comprising a negative reference to at least one of the commodities.

4. The show of claim 3, wherein the negative reference comprises a reference selected from the group consisting of a disparagement, a mockery, a parody, a joke, a funny description, a satire, a negative connotation, a negative denotation and a factual description.

5. The show of claim 1, wherein the show comprises a commercial-free format.

6. The show of claim 1, wherein the commodity is a product or a service.

7. The show of claim 1, wherein the show is formatted to be played over a network selected from the group consisting of a broadcast television network, a cable television network, a satellite television network and an internet.

8. A show comprising:
a series of episodes, each one of the episodes comprising:
(a) a plot which varies with each one of the episodes;
(b) a plurality of characters who are co-workers working for an advertisement company, at least one of the characters comprising a role in all of the episodes;
(c) at least one advertisement associated with at least one commodity which is commercially available outside of the show; and
(d) at least one noncomplimentary act performed by at least one of the characters, the noncomplimentary act, though not expressly complimenting the commodity or client, is performable to produce a promotional effect for the commodity with respect to one or more viewers of the episode.

9. The show of claim 8, wherein the advertisement is portrayed as a result of work conducted by at least one of the characters for a client of the advertisement company.

10. The show of claim 8, wherein the noncomplimentary act comprises a statement or behavior comprising a negative reference to the commodity.

11. The show of claim 10, wherein the negative reference comprises a reference selected from the group consisting of a disparagement, a mockery, a parody, a joke, a funny description, a satire, a negative connotation, a negative denotation and a factual description.

12. The show of claim 8, wherein the show comprises a commercial-free format.

13. The show of claim 8, wherein the commodity is a product or a service.

14. The show of claim 8, wherein the show is formatted to be played over a network selected from the group consisting of a broadcast television network, a cable television network, a satellite television network and an internet.

15. A data storage device comprising:
data associated with a show, the show comprising a series of episodes, each one of the episodes comprising:
(a) a plot which varies with each one of the episodes;
(b) a plurality of characters who are co-workers working for an advertisement company, at least one of the characters comprising a role in all of the episodes;
(c) at least one advertisement associated with at least one commodity which is commercially available outside of the show; and
(d) at least one noncomplimentary act performed by at least one of the characters, the noncomplimentary act, though not expressly complimenting the commodity or client, is performable to produce a promotional effect for the commodity with respect to one or more viewers of the episode.

16. The data storage device of claim 15, wherein the data storage device comprises device selected from the group consisting of a database, a server, a disk and a magnetic tape.

17. The data storage device of claim 15, wherein the show is formatted to be played over a network selected from the group consisting of a broadcast television network, a cable television network, a satellite television network and an internet.

18. The data storage device of claim 15, wherein the noncomplimentary act comprises a statement or behavior comprising a negative reference to the commodity or client.

19. The data storage device of claim 15, wherein the negative reference comprises a reference selected from the group consisting of a disparagement, a mockery, a parody, a joke, a funny description, a satire, a negative connotation, a negative denotation and a factual description.

20. The data storage device of claim 15, wherein the show comprises a commercial-free format.

21. The data storage device of claim 15, wherein the commodity is a product or a service.

22. A system for producing a promotional effect with respect to a commodity, the system comprising:
a show adapted to be implemented by an implementer, the show comprising a series of episodes, each one of the episodes comprising:
(a) a plot which varies with each one of the episodes;
(b) a plurality of characters who are co-workers working for an advertisement company, at least one of the characters comprising a role in all of the episodes;
(c) at least one advertisement associated with at least one commodity which is commercially available outside of the show; and
(d) at least one noncomplimentary act performed by at least one of the characters, the noncomplimentary act, though not expressly complimenting the commodity or client, is performable to produce a promotional effect for the commodity with respect to one or more viewers of the episode; and
a payment arrangement obligating at least one payor to provide a payment to the implementer, the payor being affiliated with marketing or selling the commodity outside of the show.

23. The system of claim 22, wherein the implementer comprises an entity selected from the group consisting of a producer, a developer and a broadcaster.

24. The system of claim 22, wherein the payor comprises an entity selected from the group consisting of a manufacturer of the commodity, an agent for the manufacturer, a provider of the commodity, an agent of the provider, a distributor of the commodity, a marketer for the commodity, and any entity directly or indirectly engaged in commercializing the commodity.

25. The system of claim 22, wherein the show comprises a plurality of different advertisements associated with a plurality of different commodities, each one of the commodities being commercially available outside of the show.

26. The system of claim 25, wherein the payment arrangement specifies a plurality of different payment obligations, each one of the payment obligations obligating a different payor to provide a different payment to the implementer, the payments being associated with different ones of the commodities, amounts of the payments varying with degrees of involvements of the commodities in the show.

27. The system of claim 22, wherein the noncomplimentary act comprises a statement or behavior comprising a negative reference to the commodity or client.

28. The system of claim 27, wherein the negative reference comprises a reference selected from the group consisting of a disparagement, a mockery, a parody, a joke, a funny description, a satire, a negative connotation, a negative denotation and a factual description.

29. The system of claim 22, wherein the show comprises a commercial-free format.

30. The system of claim 22, wherein the advertisement is usable in a commercial apart from the show.

31. The system of claim 22, wherein the commodity is a product or a service.

32. The system of claim 22, wherein the show is formatted to be played over a network selected from the group consisting of a broadcast television network, a cable television network, a satellite television network and an internet.

33. A system for promoting a commodity, the system comprising:
a show adapted to be implemented by a show implementer, the show comprising a series of episodes, each one of the episodes comprising:
(a) a plot which varies with each one of the episodes;
(b) a plurality of characters who work in an advertisement field, at least one of the characters comprising a role in all of the episodes;
(c) at least one advertisement associated with at least one commodity which is commercially available outside of the show; and
(d) at least one noncomplimentary act performed by at least one of the characters, the noncomplimentary act, though not expressly complimenting the commodity or client, is performable to produce a promotional effect for the commodity with respect to one or more viewers of the episode;
a payment arrangement obligating at least one payor to provide a payment to the show implementer, the payor being affiliated with marketing or selling the commodity outside of the show; and
a computer system executable by a processor operating over a data network, the computer system being operable to control a network site of an advertisement company, the computer system comprising a submission module which enables a plurality of network users to submit advertisement concepts to the advertisement company through the network site, the advertisement concepts being associated with proposed advertisements which are reviewable for use in the show.

34. The system of claim 33, wherein the payor comprises an entity selected from the group consisting of a manufacturer of the commodity, an agent for the manufacturer, a provider of the commodity, an agent of the provider, a distributor of the commodity, a marketer for the commodity, and any entity directly or indirectly engaged in commercializing the commodity.

35. The system of claim 33, wherein the show implementer comprises an entity selected from the group consisting of a producer, a developer and a broadcaster.

36. The system of claim 33, which comprises a compensation arrangement usable by the advertisement company to provide payments to the network users who submit the advertisement concepts, an amount of each payment depending upon whether the associated advertisement concept is used in the show.

37. The system of claim 33, which comprises an employment status grantable to at least one of the network users, the employment status indicating that the network user is a mock employee or real employee of the advertisement company.

38. The system of claim 33, wherein the show comprises at least one noncomplimentary act performed by at least one of the characters, the noncomplimentary act, though not expressly complimenting the commodity or client, is performable to produce a promotional effect for the commodity with respect to one or more viewers of the episode.

39. The system of claim 33, wherein the commodity is a product or a service.

40. The system of claim 33, wherein the show is formatted to be implemented over a network selected from the group consisting of a broadcast television network, a cable television network, a satellite television network and an internet.
